(19) United States
(12) Patent Application Publication
(10) Pub. No.: US 2021/0030103 A1
(43) Pub. Date: Feb. 4, 2021

(54) Sandal Having Releasable Strap Fastening

(71) Applicant: Benno Reichard, Zurich (CH)

(72) Inventor: Benno Reichard, Zurich (CH)

(21) Appl. No.: 16/966,464

(22) PCT Filed: Feb. 15, 2019
(86) PCT No.: PCT/DE2019/100147

§ 371 Date: Jul. 31, 2020

(30) Foreign Application Priority Data
Feb. 15, 2018 (DE) 202018100824.2

(51) Int. Cl. A43B 3/12; A43B 1/00; A43B 3/10

(52) U.S. Cl. CPC A43B 3/122; A43B 3/105; A43B 1/0063

(57) ABSTRACT

A sandal having releasable strap fastening, comprising a sole, at least one strap and at least one clamping buckle and/or at least one anchor buckle. According to the invention, the sandal is modularly constructed and can be easily assembled and disassembled. The sole and the at least one strap are connected to each other by guiding the at least one strap through eyes provided in the sole. The two ends of the at least one strap, which form two strap ends, are either fastened to the strap again by means of at least one of the clamping buckles so as to form a loop or are anchored to one of the eyes by means of at least one of the anchor buckles.

### CROSS REFERENCE TO RELATED APPLICATIONS

This application is the U.S. national stage of International Application No. PCT/DE2019/100147, filed on 2019 Feb. 15. The international application claims the priority of DE 202018100824.2 filed on 2018 Feb. 15; all applications are incorporated by reference herein in their entirety.

### BACKGROUND

The invention relates to a sandal with releasable strap fastening and a kit for the sandal. Sandals have the decisive advantage over closed shoes that they give the wearer an open and liberating feeling at the feet and allow good ventilation of the feet. They are mainly worn at air temperatures above 20° Celsius. According to conventional construction, they have a sole and at least one strap. The sole covers and protects the sole of the foot and the strap runs at least over the instep of the foot to keep the sole on the foot. The strap and the sole are fixed to each other in most cases. In the widely used design with a multi-layered sole, the ends of the straps are glued between two of the layers.

Releasable systems already exist as well. In sandals where the entire sole is made of the same part (e.g. flip-flops), for example, the strap ends are led directly through openings provided in the sole, are fixed by means of an anchor device and can thus often be detached from the sole again. This is common for straps made of plastic, which are usually produced by injection molding and the anchor device is therefore already realized by the shape of the strap ends. If, on the other hand, the straps are designed from a flat strip, an anchor device or a loop may be formed by a seam, gluing, welding, glued or sewn on hook and loop fastener or, for example, a riveted additional element. Connections designed in this way no longer allow the sandal to be completely disassembled into its individual components in an easy manner or without destruction.

Utility model no. DE 20 2015 008 872 U1 already formulates a very convincing invention for reasons of recyclability and technical or ecological sustainability, which is aimed at closed shoes and proposes, among other things, a completely detachable shoe outer construction. According to the cited prior art utility model, a “shoe sole element” and a “shoe upper element” are joined together by means of a “connecting element” in such a way that the three components can be separated again. However, it is not a mandatory and decisive element of the invention to allow non-destructive separation from the individual components of the connecting element, i.e. such as the strap and the buckle.

As an improvement over the prior art enriched by utility model no. DE20 2015 008 872 U1 as well as the general prior art, the present invention is based on the objective of being able to completely disassemble a sandal as simply as possible into all its individual components and thereby constructively dispense of seams, welding, gluing or other connections that cannot be separated without destruction.

### SUMMARY

The invention relates to a sandal having releasable strap fastening, comprising a sole (1), at least one strap (2) and at least one clamping buckle (4) and/or at least one anchor buckle (3). According to the invention, the sandal is modularly constructed and can be easily assembled and disassembled. The sole (1) and the at least one strap (2) are connected to each other by guiding the at least one strap (2) through eyes (5) provided in the sole (1). The two ends of the at least one strap (2), which form two strap ends, are either fastened to the strap (2) again by means of at least one of the clamping buckles (4) so as to form a loop or are anchored to one of the eyes (5) by means of at least one of the anchor buckles (3).

### DETAILED DESCRIPTION

The object of the present invention thus is, firstly, to simplify assembly and, secondly, to achieve a simple and non-destructive replacement of the individual components (sole, straps, buckles). An additional aim is to guarantee simple disassembly for disposal in a varietally pure manner.

This object is achieved with the features cited in claims 1 and 16. Advantageous modifications are proposed in the dependent claims. This makes it possible to form a loop or anchorage without the at least one strap having a material bond, in particular a seam, a weld, an adhesive bond and/or a riveted joint.

The strap ends are passed through the eyes integrated in the sole and are either anchored to the eye by fastening an anchor buckle to the strap end or are turned over and additionally clamped to the strap by means of a clamping buckle. The clamping buckles and the anchor buckles are designed such that they can be opened again after closing and can thus be detached from the strap. One or more of the buckles may optionally be designed such that they both fix the strap end and allow the strap to be tightened and loosened for ideal adaptation to any foot shape. It is possible to use existing clamping buckle principles, such as closing clips, which may form an anchorage when attached to the strap end, or, for example, conventional belt buckles in which one strap end is clamped and the other strap end is guided through the belt buckle and is variably clamped in different positions by closing, for example for flexible circumferential adjustment.

In contrast to the prior art, in the sandal according to the invention, the at least one strap in combination with the at least one anchor and/or clamping buckle thus assumes the function of the shoe upper element. In this respect, specific requirements exist for the at least one strap, the design of the eyes and the construction of the anchor or clamping buckles. The direct skin contact with the strap and the anchor or clamping buckle results in requirements for the strap material regarding strap surface, stiffness, fastness, skin compatibility and cleaning, as well as for the construction and material of the anchor or clamping buckle regarding material, surface, edge quality and safety against pinching. The design of the eyes as a connection between the strap and the sole must have sufficient strength to withstand tensile stress on the one hand, and on the other hand allow easy threading through when installing or replacing the strap.

The invention advantageously achieves that the individual assembly steps are reduced to a minimum and no additional machines or devices are required for the assembly. The sandal according to the invention can therefore be disassembled at any time and recomposed in a modular fashion. The user can thus compose his sandals himself and replace the components as he wishes. This could eliminate the assembly step in the manufacturing process. This would allow additional labor costs to be saved and thus make it easier to produce at a European location without high manufacturing costs resulting in a high product price due to manual assembly. At the end of the product life cycle, it is possible to recycle or compost the sandal in its individual components without prior laborious disassembly into these components being necessary.

### BRIEF DESCRIPTION OF THE DRAWINGS

Possible embodiment examples of the invention are explained using FIGS. 1, 2 and 3. In the figures:

FIG. 1: is a schematic perspective view of an embodiment of all individual components of the sandal;

FIG. 2: is a schematic perspective view of an embodiment of a fully assembled sandal; and

FIG. 3: is a side view of a fully assembled sandal in an embodiment with a two-component sole and the strap end fixation with one slidable clamping buckle each.

### DETAILED DESCRIPTION OF THE PREFERRED EMBODIMENTS

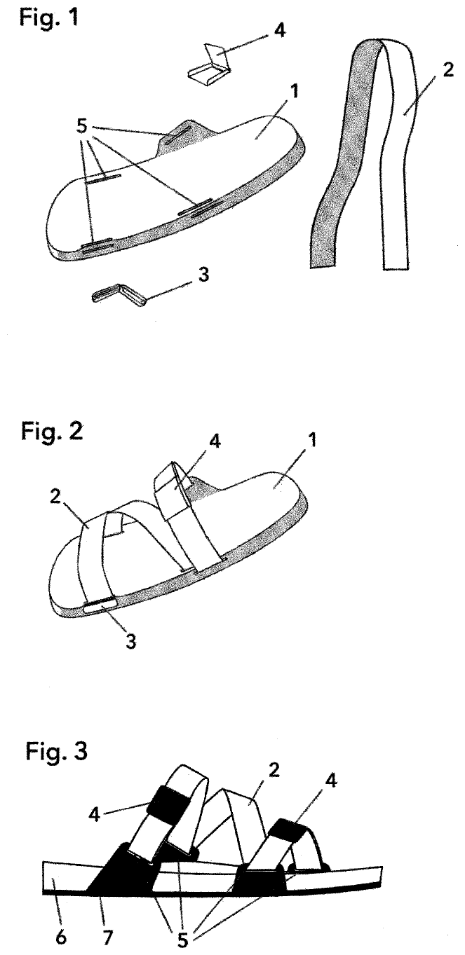

FIG. 1 schematically shows an embodiment example of the sandal in which it is disassembled into its individual components, i.e. is available as a kit. Said kit comprises a sole 1 with the integrated eyes 5, a strap 2, a simple anchor buckle 3 and a clamping buckle 4 in an open state, which is shown in a version slidable on the strap 2.

FIG. 2 shows the same embodiment example in the assembled state. Here the strap 2 is guided through all eyes 5 and anchored at one end with the simple anchor buckle 3 to one of the eyes 5 and with the other end, after passing through another one of the eyes 5, turned over and fastened to the strap 2 with the slidable clamping buckle 4.

FIG. 3 shows a fully assembled embodiment example where the sole 1 consists of a softer component 6 for cushioning and shaping the footbed and a harder component 7, with the harder component 7 both forming the eyes 5 and shaping the undersole to provide abrasion and puncture resistance.

### LIST OF REFERENCE NUMERALS

1 sole

2 strap

3 anchor buckle

4 clamping buckle

5 eyes

6 softer component (of the sole)

7 harder component (of the sole)

1. A sandal having releasable strap fastening, comprising a sole (1), at least one strap (2) and at least one clamping buckle (4) and/or at least one anchor buckle (3), wherein the sandal is modularly constructed and can be easily assembled and disassembled, wherein the sole (1) and the at least one strap (2) are connected to each other by guiding the at least one strap (2) through eyes (5) provided in the sole (1), characterized in that the two ends of the at least one strap (2), which form two strap ends, are either fastened to the strap (2) by means of at least one of the clamping buckles (4) so as to form a loop or are anchored to one of the eyes (5) by means of at least one of the anchor buckles (3).

2. The sandal according to claim 1, wherein the at least one clamping buckle (4) and/or the at least one anchor buckle (3) is effective by force closure and can be opened manually after closing and detached from the strap (2).

3. The sandal according to claim 1, wherein the at least one clamping buckle (4) is configured to fix a turned-over end of the strap (2) back to the strap (2) so as to form a loop around one of the eyes (5) and thereby fix the strap (2) to the sole (1).

4. The sandal according to claim 3, wherein the at least one clamping buckle (4) is configured to be slidable in the open state and thus allows the shortening and lengthening of the used strap length in order to allow a flexible adaptation to the foot.

5. The sandal according to claim 1, wherein the at least one anchor buckle (3) is configured to be fastened to at least one strap end of the strap (2) to thus prevent the strap (2) from slipping through the eye (5) and thereby fix the strap (2) to the sole (1).

6. The sandal according to claim 1, wherein the at least one clamping buckle (4) and/or the at least one anchor buckle (3) are made of the same material and can be recycled in a varietally pure manner.

7. The sandal according to claim 1, wherein the eyes (5) integrated in the sole (1) are designed as an aperture, slit or formed loop.

8. The sandal according to claim 1, wherein the sole (1) consists of only one component and the cushioning property is realized by constructional cushioning by means of a 3D structure.

9. The sandal according to claim 1, wherein the sole (1) is made of two components connected to each other, wherein a softer component (6) both takes over the cushioning function under the sole of the foot and forms a footbed, and a harder component (7) at the edge of the sole (1) forms and/or reinforces the eyes (5) subjected to tensile stress.

10. The sandal according to claim 9, wherein the softer component (6) enables the cushioning property through a foamed structure.

11. The sandal according to claim 9, wherein the sole (1) is produced in a two-component injection molding process, wherein both components (6, 7) are formed from the same polymer and can thus also be recycled in the composite state.

12. The sandal according to claim 9, wherein the sole (1) is made of two components (6, 7) joined together by gluing, wherein the adhesive is biodegradable and wherein it is provided that both components can be separated from each other by a simple process and recycled individually.

13. The sandal according to claim 12, wherein at least one of the components (6, 7) consists of a biodegradable polymer.

14. The sandal according to claim 9, wherein the harder component (7), in addition to the formation of the eyes (5), is additionally formed at least partially as an undersole and thus additionally ensures abrasion resistance and puncture resistance.

15. The sandal according to claim 1, wherein the at least one strap (2) is made of biodegradable raw material in a varietally pure manner and is compostable.

16. A kit for a sandal according to claim 1, wherein the kit comprises a sole (1), at least one strap (2) and at least one clamping buckle (4) and/or at least one anchor buckle (3), which can be assembled and disassembled without tools, characterized in that the two ends of the at least one strap (2), which form two strap ends, can either be fastened to the strap (2) by means of at least one of the clamping buckles (4) so as to form a loop or can be anchored to one of the eyes (5) by means of at least one of the anchor buckles (3).
